(19) United States
(12) Patent Application Publication
(10) Pub. No.: US 2018/0180796 A1
(43) Pub. Date: Jun. 28, 2018

(54) BACKLIGHT MODULE AND DISPLAY DEVICE

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 15/109,415

(22) PCT Filed: May 25, 2016
(86) PCT No.: PCT/CN2016/083291

§ 371 Date: Jun. 30, 2016

(30) Foreign Application Priority Data
Apr. 6, 2016 (CN) 201610209107.6

(51) Int. Cl. F21V 8/00

(52) U.S. Cl. CPC G02B 6/0068; G02B 6/0091; G02B 6/0088; G02B 6/0031

(57) ABSTRACT

The present invention provides a backlight module including a frame body, an arc-shaped light guide plate and a backlight strip; the backlight strip includes a base plate and multiple light sources; a surface of the base plate is an arc-shaped surface; the light guide plate is provided with two opposite curved edges; a curvature of the arc-shaped surface is the same as a curvature of the curved edge; the multiple light sources are arranged on the arc-shaped surface; the arc-shaped light guide plate and the backlight strip are received in the frame; the backlight strip is located at a side of the curved edge, and a light emitting side of each light source faces toward the light guide plate. A display device is also provided.

### CROSS REFERENCE

The claims of this application have submitted to the State Intellectual Property Office of the People's Republic of China (SIPO) on Apr. 6, 2016, Application No. 201610209107.6. The priority right based on the China application has a title of “Backlight module and display device”. The entire contents of the above-mentioned patent application will be incorporated in the present application through citing.

### FIELD OF THE INVENTION

The present invention relates to a liquid crystal display technology field, and more particularly to a backlight module and a display device.

### BACKGROUND OF THE INVENTION

Along with the development of the technology, a requirement of the user for appearance and performance of a display device is not limited to a conventional flat structure. Currently on the market, a curved structure is appeared in order to meet an ergonomic design and increase the comfort of the visual and tactile of a user. Same as the structure of a flat display device, a curved display device includes a display panel, a back plate, a front frame, a plastic frame, a backlight source and so on. Wherein, the backlight source of the curved display device adopts a side light type LED (Light emitting diode). As shown in FIG. 1, each of the display panel (not shown in the figure), the back plate 1, the light guide plate 2 and the optical film 3 is a curved structure, and curvatures are the same. Wherein, a light strip 4 is a long strip structure. The light is emitted perpendicularly to a surface of the circuit board of the light strip. A surface of the light strip away from the LED is adhered to a left or a right side wall of the back plate. As shown in FIG. 1, the light emitted from the light strip is evenly reflected to an optical film group, and the light can transmit to the display panel after passing through the optical film group. However, the light strip is designed to be placed at left and right sides of the backlight source. After reflecting by the light guide plate, a brightness at middle is greater than a brightness at left and right sides such that the brightness of the display panel is uneven.

### SUMMARY OF THE INVENTION

The purpose of the present invention is to provide a backlight module and a display device in order to ensure a luminous uniformity of the display device.

The present invention provides a display device comprising a curved display panel and a backlight source for providing a light source for the curved display panel; the backlight module includes a frame body, an arc-shaped light guide plate and a backlight strip; the backlight strip includes a base plate and multiple light sources; a surface of the base plate is an arc-shaped surface; the light guide plate is provided with two opposite curved edges; a curvature of the arc-shaped surface is the same as a curvature of the curved edge; the multiple light sources are arranged on the arc-shaped surface; the arc-shaped light guide plate and the backlight strip are received in the frame; the backlight strip is located at a side of the curved edge, and a light emitting side of each light source faces toward the light guide plate.

Wherein, the curved display panel is a liquid crystal curved display panel.

Wherein, the base plate includes a scattering aluminum plate and a flexible circuit board dispose on the scattering aluminum plate, the arc-shaped surface is a surface of the flexible circuit board.

Wherein, a side surface of each light source is a light-emitting surface.

Wherein, a thickness of each location of the light guide plate is the same.

Wherein, the backlight module further includes an optical film, the optical film is a curved optical film and a curvature of the optical film is the same as a curvature of the light guide plate.

Wherein, the number of the backlight strip is two, and are respectively located at sides of two curved edges of the light guide plate.

In the display device of the present invention, a curvature of the backlight strip is the same as a curvature of the light guide plate, a light emitting side is a side surface of the backlight strip, and directly facing toward the curved edge of the light guide plate. The backlight strip is in parallel with the curved edge of the light guide plate. The light emitted from the light source is propagated in parallel along the light guide plate so as to improve the brightness uniformity of the backlight source and increase the uniformity.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a backlight module of a conventional art;

FIG. 2 is a schematic diagram of a backlight module of an embodiment of the present invention;

FIG. 3 is a schematic diagram of a side surface of a backlight source of the backlight module shown in FIG. 1; and

FIG. 4 is a top view of a backlight strip.

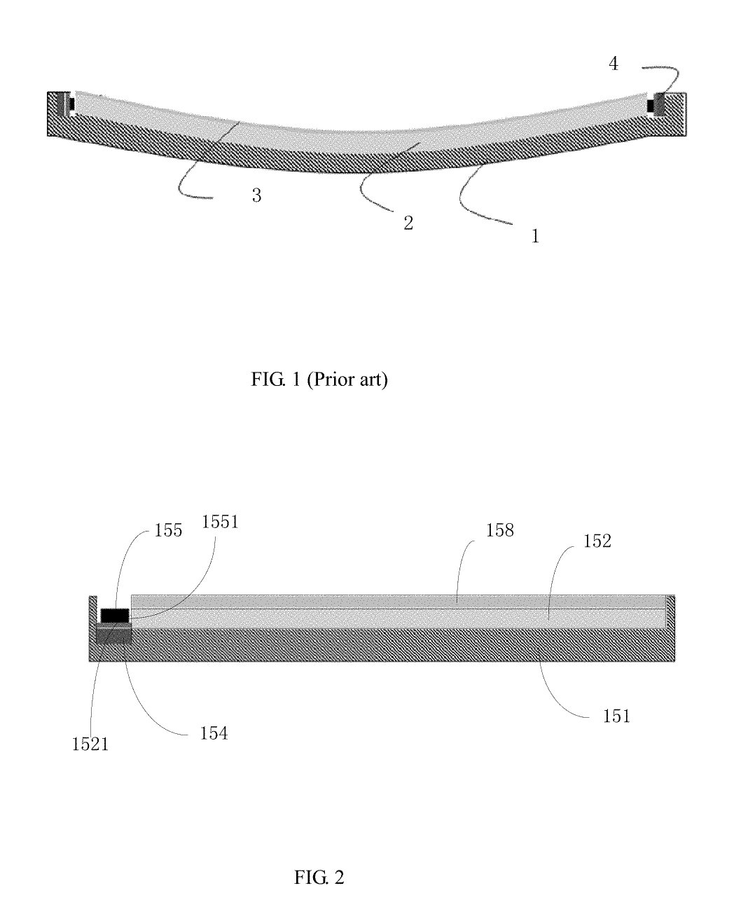

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

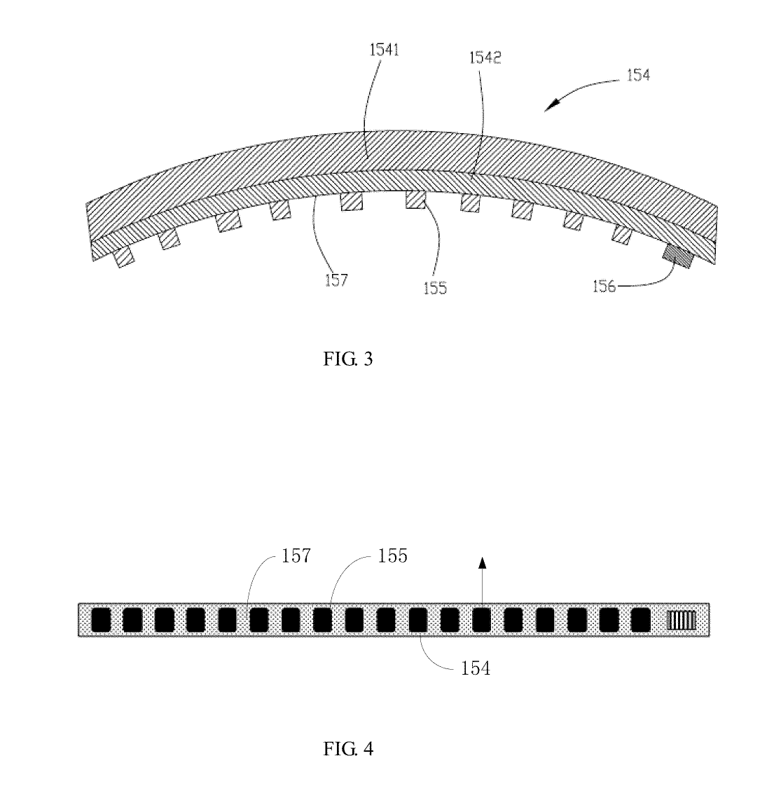

With reference to FIG. 2 and FIG. 3, the preferred embodiment of the present invention provides a backlight module and a display device. The display device includes a curved display panel 10 and a backlight module 15 for providing a backlight source for the curved display panel 10. The backlight module 15 includes a frame body 151, an arc-shaped light guide plate 152 and a backlight strip 154.

The backlight strip 154 includes a base plate and multiple light sources 155, a surface of the base plate is an arc-shaped surface 157. The light guide plate 152 is provided with two opposite curved edges 1521. A curvature of the arc-shaped surface 157 is the same as a curvature of the curved edge 1521. The multiple light sources 155 are arranged on the arc-shaped surface 157. The arc-shaped light guide plate 152 and the backlight strip 154 are received inside the frame body 151. The backlight strip 154 is located at a side of the two curved edges 1521, and a light emitting side 1551 of the light source 155 faces toward the light guide plate 152. Wherein, the curved display panel is a liquid crystal curved display panel. A side surface of each light source 155 is the light emitting side 1551 (an arrow shown in FIG. 4 is the light emitting direction), and the side surfaces of the light sources are disposed to be fitted with the curved edge 1521. Comparing with the light sources being disposed at two sides and a top surface of the light source face toward the light guide plate, in the present invention, a side of the light source faces toward the light guide plate in order to avoid tilting to affect the entering of the light because of the gravity of itself.

In the present embodiment, the light guide plate 152 also includes two parallel straight edges. The two straight edges are connected with the two curved edges 1521. Wherein, a curvature of each curved edge 1521 is the same as a curvature of the curved display panel. A thickness of each location of the light guide plate 152 is the same to ensure the uniformity of the emitted light. The frame body 151 includes a peripheral frame and a carrier edge surrounds the peripheral frame. The peripheral frame and the carrier edge forms a space for receiving the light guide plate 152 and the backlight strip 154. Wherein, the backlight module further includes an optical film 158. The optical film is a curved optical film and a curvature of the optical film 158 is the same as a curvature of the light guide plate. The optical film is adhered to a light emitting surface of the light guide plate 152.

Furthermore, the base plate includes a scattering aluminum plate 1541 and a flexible circuit board 1542 dispose on the scattering aluminum plate 1541. The arc-shaped surface 157 is a surface of the flexible circuit board 1542, that is, a surface away from the flexible circuit board 1542. The scattering aluminum plate 1541 is a long strip body, an arc-shaped plate having an arc-shaped surface or a plate body having an arc-shaped slot. The arc-shaped surface or the arc-shaped slot is used for carrying the flexible circuit board 1542 in order to ensure the curvature of the arc-shaped surface 157 of the flexible circuit board 1542. In the present embodiment, a surface of the scattering aluminum plate 1541 is provided with an arc-shaped slot, that is, a bottom wall of the slot is arc-shaped. The flexible circuit board 1542 is adhered to the bottom wall of the slot to form the arc-shaped surface. A surface of the scattering aluminum plate 1541 opposite to the arc-shaped slot is a flat surface for convenient to be installed into the frame body 151 and ensure an assembly stability of the light strip. A facing direction of the arc-shaped surface 157 is the same as a facing direction of the light-emitting surface of the light guide plate 152. A terminal of the base plate is provided with a driving connector 156 for connecting with a power source in order to drive the flexible circuit board.

Furthermore, a side surface of the light source 155 is a light-emitting surface. It can be understood that the number of the backlight strip is two, and are respectively located at sides of two curved edges 1521 of the light guide plate 152.

In the display device of the present invention, a curvature of the backlight strip 154 is the same as a curvature of the light guide plate 152, a light emitting side is a side surface of the backlight strip 154, and directly facing toward the curved edge of the light guide plate 152. The backlight strip is in parallel with the curved edge of the light guide plate 152. The light emitted from the light source 155 is propagated in parallel along the light guide plate so as to improve the brightness uniformity of the backlight source and increase the uniformity.

The above embodiment does not constitute a limitation of the scope of protection of the present technology solution. Any modifications, equivalent replacements and improvements based on the spirit and principles of the above embodiments should also be included in the protection scope of the present technology solution.

What is claimed is:

1. A backlight module includes a frame body, an arc-shaped light guide plate and a backlight strip; the backlight strip includes a base plate and multiple light sources; a surface of the base plate is an arc-shaped surface; the light guide plate is provided with two opposite curved edges; a curvature of the arc-shaped surface is the same as a curvature of the curved edge; the multiple light sources are arranged on the arc-shaped surface; the arc-shaped light guide plate and the backlight strip are received in the frame; the backlight strip is located at a side of the curved edge, and a light emitting side of each light source faces toward the light guide plate.

2. The backlight module according to claim 1, wherein, the base plate includes a scattering aluminum plate and a flexible circuit board dispose on the scattering aluminum plate, the arc-shaped surface is a surface of the flexible circuit board.

3. The backlight module according to claim 2, wherein, a side surface of each light source is a light-emitting surface.

4. The backlight module according to claim 1, wherein, a thickness of each location of the light guide plate is the same.

5. The backlight module according to claim 4, wherein, the backlight module further includes an optical film, the optical film is a curved optical film and a curvature of the optical film is the same as a curvature of the light guide plate.

6. The backlight module according to claim 1, wherein, the number of the backlight strip is two, and are respectively located at sides of two curved edges of the light guide plate.

7. A display device comprising a curved display panel and a backlight source for providing a light source for the curved display panel; the backlight module includes a frame body, an arc-shaped light guide plate and a backlight strip; the backlight strip includes a base plate and multiple light sources; a surface of the base plate is an arc-shaped surface; the light guide plate is provided with two opposite curved edges; a curvature of the arc-shaped surface is the same as a curvature of the curved edge; the multiple light sources are arranged on the arc-shaped surface; the arc-shaped light guide plate and the backlight strip are received in the frame; the backlight strip is located at a side of the curved edge, and a light emitting side of each light source faces toward the light guide plate; the curvature of the curved edge is the same as a curvature of the curved display panel.

8. The display device according to claim 7, wherein, the curved display panel is a liquid crystal curved display panel.

9. The display device according to claim 7, wherein, the base plate includes a scattering aluminum plate and a flexible circuit board dispose on the scattering aluminum plate, the arc-shaped surface is a surface of the flexible circuit board.

10. The display device according to claim 9, wherein, a side surface of each light source is a light-emitting surface.

11. The display device according to claim 7, wherein, a thickness of each location of the light guide plate is the same.

12. The display device according to claim 11, wherein, the backlight module further includes an optical film, the optical film is a curved optical film and a curvature of the optical film is the same as a curvature of the light guide plate.

13. The display device according to claim 7, wherein, the number of the backlight strip is two, and are respectively located at sides of two curved edges of the light guide plate.
